(19) United States
(12) Patent Application Publication
(10) Pub. No.: US 2026/0217106 A1
(43) Pub. Date: Jul. 30, 2026

(54) ELECTRIC VEHICLE AND METHOD OF OPERATING THE ELECTRIC VEHICLE

(71) Applicant: AUDI AG, Ingolstadt (DE)

(72) Inventors: Paul BÖCKENHOFF, Ingolstadt (DE); Alexander GUMMER, Ingolstadt (DE)

(21) Appl. No.: 19/462,797

(22) Filed: Jan. 28, 2026

(30) Foreign Application Priority Data
Jan. 30, 2025 (DE) 102025103378.1

(51) Int. Cl. B60K 11/04

(52) U.S. Cl. CPC B60K 11/04

(57) ABSTRACT

A method of operating an electric vehicle is disclosed, and may include detecting an extreme operating situation or an imminent extreme operating situation of the electric vehicle requiring a temperature-induced power limitation of at least one constituent for a drive of the electric vehicle or a temperature-induced power reduction of the at least one constituent, and evaporating a cryogenic coolant in an evaporator heat exchanger unit, such that a temperature of primary coolant flowing through a coolant circuit is maintained or lowered below a threshold value, such that the power limitation or the power reduction of the at least one constituent is suppressed. The at least one constituent and the evaporator heat exchanger unit may be fluid-mechanically integrated. The evaporator heat exchanger unit may be configured to be fluid-mechanically connected to a tank configured to hold the cryogenic coolant.

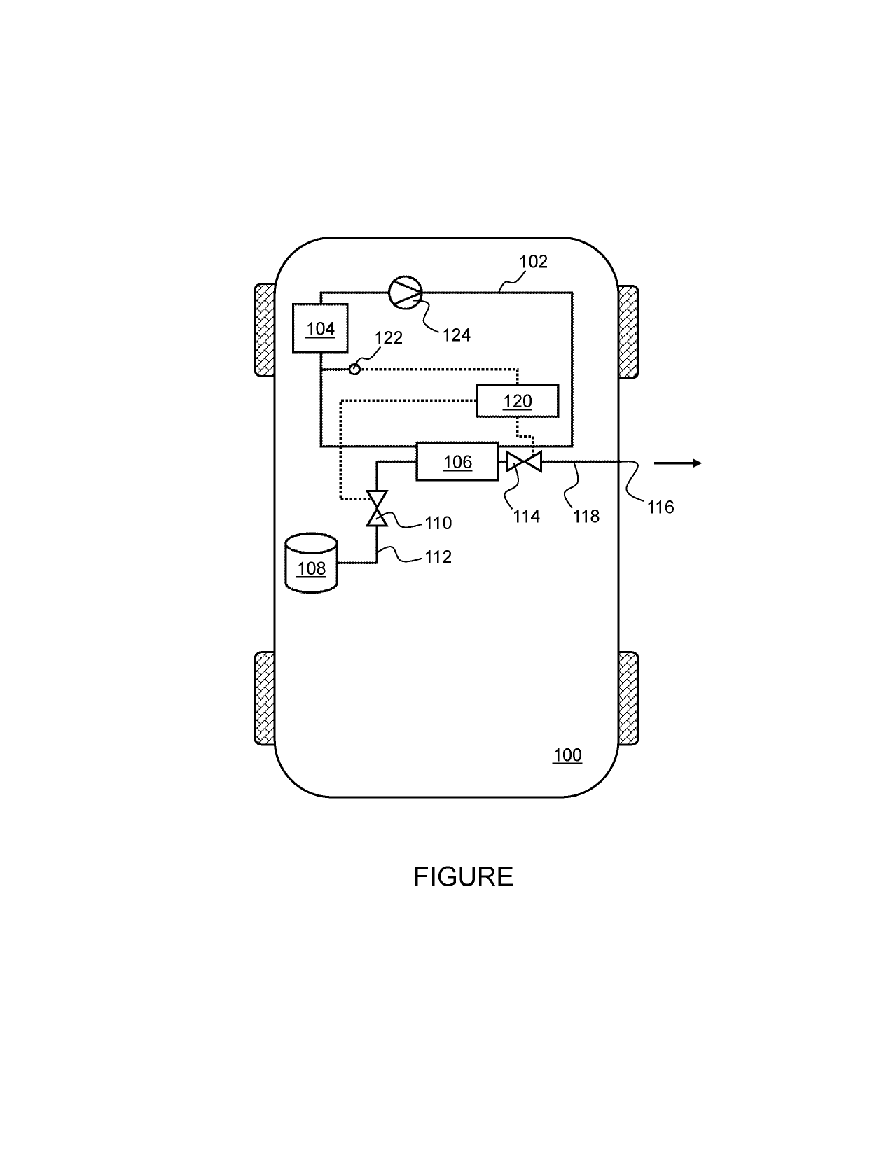

### BACKGROUND

### Technical Field

The present disclosure relates to a method of eliminating or delaying derating of constituents of an electric vehicle, in particular eliminating or delaying derating of constituents of an electric vehicle by evaporating a cryogenic coolant in an evaporator heat exchanger unit.

### Description of the Related Art

The use of a cryogenic coolant, such as nitrogen, in vehicles for cooling is known from publications CN201729046U and CN202156263U, for example. In this case, liquid nitrogen flows through a heat exchanger so that either the interior or housing parts can be cooled via this heat exchanger. Furthermore, DE102012104520A1 describes the possibility that a heat exchanger through which nitrogen flows may also be integrated into the conventional coolant circuit of a vehicle, in order to reduce the temperature of the coolant in the coolant circuit in extreme operating situations.

Due to thermal limits, the performance of electric motors in electric vehicles is limited, meaning that they may no longer utilize their full power under high loads. This is always the case when the cooling capacity for the constituents of the drive is not sufficient to prevent component damage. The drive train, such as the power electronics and the battery of the electric vehicle, are limited to defined maximum temperatures. Such thermal problems occur particularly when driving under extreme operating situations, such as driving on race tracks, during steep off-road driving, or when driving at continuously high speeds. An extreme operating situation also exists during the acceleration phases, in which increased heat generation occurs, so that the heat must be dissipated, which is also only possible to a limited extent.

### BRIEF SUMMARY

The present disclosure provides a method of operating an electric vehicle and a corresponding electric vehicle, in which power derating of individual constituents of the drive may be effectively avoided or delayed.

The method according to the present disclosure is provided for operating an electric vehicle, in which the electric vehicle comprises a coolant circuit through which coolant flows, and in which at least one constituent for the drive of the electric vehicle and an evaporator heat exchanger unit are fluid-mechanically integrated, wherein the evaporator heat exchanger unit may be configured to be fluid-mechanically connected to a tank for cryogenic coolant. The method may include the following steps:

detecting an extreme operating situation or an imminent extreme operating situation of the electric vehicle that may require a temperature-induced power limitation of the constituent or a temperature-induced power reduction of the constituent, and

evaporating the cryogenic coolant in the evaporator heat exchanger unit, in order to maintain or lower the temperature of the coolant in the coolant circuit below a threshold value, so that the power limitation or the power derating of the constituent is suppressed.

In this way, a technical system is created in which cryogenic coolant, such as liquid nitrogen, is used to temporarily increase the system cooling capacity of electric vehicles, which means that a corresponding “cooling boost” may be achieved. Such a configuration may increase the performance capability of electric vehicles under extreme conditions and power degradation, i.e., derating, may either not occur at all or may occur only with a significant delay compared to the normal case.

Liquid nitrogen has proven to be particularly advantageous as a cryogenic coolant, as liquid nitrogen has an extremely low boiling temperature, which makes liquid nitrogen ideal as a coolant for high-performance applications. A large amount of heat may be dissipated in a short time by vaporizing the nitrogen, because additional vaporization cooling may occur due to the existing “liquid-gaseous” phase transition.

Additional advantages may be realized if, when an extreme operating situation or an imminent extreme operating situation is detected, only a predefined amount of the cryogenic coolant is introduced into the evaporator heat exchanger unit, and if the cryogenic coolant is only discharged from the evaporator heat exchanger unit when the cryogenic coolant therein has completely evaporated. Such an operation may ensure that the cryogenic coolant is not consumed unnecessarily and that the maximum possible cooling capacity of the cryogenic coolant within the evaporator heat exchanger unit is utilized. In other words, the cryogenic coolant may remain in the evaporator heat exchanger unit for as long as the cryogenic coolant may contribute to cooling. Only then may the cryogenic coolant be discharged.

If an increased cooling capacity is required, additional cryogenic coolant may be introduced into the evaporator heat exchanger unit intermittently or continuously when a sustained extreme operating situation is detected. Although such an operation increases the nitrogen consumption, the operation may provide the necessary cooling in the coolant circuit, so that no derating, i.e., no power limitation or power reduction of the constituent, is required.

If an extreme operating situation or an imminent extreme operating situation is detected, an inlet valve may be opened to introduce the liquid cryogenic coolant into the evaporator heat exchanger unit, which may be integrated into a supply line running from the tank to the evaporator heat exchanger unit.

The tank for the cryogenic coolant, such as the nitrogen tank, may be a specially insulated tank that is integrated into the vehicle. However, this tank may also be configured to be replaceable. The tank may be thermally insulated to keep the cryogenic liquid coolant at extremely low temperatures and to prevent unwanted evaporation. The tank may also be configured to be sufficiently robust to withstand the pressure of the cryogenic coolant.

The inlet valve may be a solenoid valve, for example, wherein the cryogenic coolant flows automatically into the evaporator heat exchanger unit when the inlet valve is open, because there is a sufficiently high pressure of the cryogenic coolant in the tank. The supply line may therefore be configured to be pump-free.

Once the cryogenic coolant has completely evaporated in the evaporator heat exchanger unit, an outlet valve may be opened to discharge the cryogenic coolant, which may be exclusively in gaseous form, from the evaporator heat exchanger unit, which may be integrated into an outlet line running from the evaporator heat exchanger unit to an outlet to the vehicle surroundings.

Here, too, the outlet valve may be configured as a solenoid valve, wherein the outlet line may also be configured to be pump-free. The pressure of the evaporated cryogenic coolant may be high enough to be discharged to the environment. If the cryogenic coolant is nitrogen, the cryogenic coolant may be discharged to the environment without concern, as the air surrounding the electric vehicle already has a high nitrogen content.

In order to realize intelligent control of the additional cooling capacity, an imminent extreme operating mode may be determined predictively. In this way, it may be possible to react to any performance derating of the constituents of the drive train of the electric vehicle at an early stage, so that the power derating does not have to be used at all.

In this context, the predictive determination of the extreme operating mode may be carried out on the basis of data on the operating history and/or on the basis of navigation data and/or on the basis of weather data and/or on the basis of other environmental data, for example, sections of the route ahead, the vehicle inclination or the like.

A thermal power reserve may also be created by the method according to the present disclosure, namely, when the temperature in the coolant circuit is temporarily lowered before the extreme operating mode occurs; heat may thus be removed from the coolant in the coolant circuit by the cryogenic coolant at an early stage, so that a subsequent power limitation or power reduction of the constituents in the coolant circuit may be prevented.

The presence of extreme operating situations may not be checked in every case, so that it is possible for a user to activate the corresponding monitoring by actuating a selector switch. In this context, it is therefore possible that monitoring for the extreme operating situation or for an imminent extreme operating situation may only take place when a predefined driving profile is set, wherein at least one of the existing driving profiles does not require said monitoring for the extreme operating situation. For example, the “Offroad” or “Race” profiles may be used as driving profiles for monitoring.

The control may be configured to be intelligent, so that the control may automatically initiate the introduction of cryogenic coolant into the evaporator heat exchanger unit for additional cooling when required. In situations where there is no extreme situation, the control does not initiate any additional cooling.

The advantages, advantageous embodiments, and effects discussed in connection with the method according to the present disclosure also apply in the same way to the electric vehicle according to the present disclosure. The electric vehicle comprises a control unit that is configured to carry out the method described above, in all the embodiments described above.

The features and combinations of features mentioned above in the description, as well as the features and combinations of features mentioned below in the description of the figure and/or shown solely in the figure, may be used not only in the combination indicated in each case, but also in other combinations or on their own, without departing from the scope of the present disclosure. Thus, embodiments that are not explicitly shown or discussed in the figure, but that result from the discussed embodiments and may be produced by separate combinations of features, are also to be regarded as comprised and disclosed by the present disclosure.

### BRIEF DESCRIPTION OF THE SEVERAL VIEWS OF THE DRAWINGS

The Figure a schematic representation of an electric vehicle for carrying out the method according to the present disclosure.

### DETAILED DESCRIPTION

The Figure schematically shows an electric vehicle 100, which is formed with a coolant circuit 102. In the Figure, lines showing flow of fluids are shown as solid lines, and communication connections are shown as dotted lines. A constituent 104 for the drive of the electric vehicle 100 is fluid-mechanically integrated in said coolant circuit 102. The constituent 104 may be, for example, an electric motor, a battery pack, or the like. In order to be able to determine the temperature of the coolant within the coolant circuit 102, a temperature sensor 122 may additionally be present upstream of the constituent 104. However, the constituent 104 itself may also have a corresponding temperature sensor. In any case, a sensor signal for the temperature in the coolant circuit 102 may be provided to a control unit 120, which may also be present, via a communication connection. A substantially conventional circulating pump 124 may be provided in the coolant circuit 102 for circulating the coolant flowing therein.

Upstream of the constituent 104, an evaporator heat exchanger unit 106 is also integrated into the coolant line of the coolant circuit 102, which may be configured to be fluid-mechanically connected to a tank 108 for cryogenic coolant, such as for nitrogen, as is the case in the embodiment shown in the Figure. In order to convey the nitrogen from the tank 108 into the evaporator heat exchanger unit 106, a supply line 112 is provided, into which an inlet valve 110, which may be formed as a solenoid valve, may be integrated. The control unit 120 may also be in a communication connection with this inlet valve 110. Downstream of the evaporator heat exchanger unit 106 there is an outlet line 118, into which an outlet valve 114, which may be formed as a solenoid valve, may also be integrated, which, in the present case, is also communicatively connected to the control unit 120. The outlet line 118 may lead to the environment, so that an outlet 116 of the outlet line 118 may be provided for discharging evaporated nitrogen to the environment of the electric vehicle 100. In such a configuration, heat may be extracted from the conventional coolant in the coolant circuit 102 as required by way of the cryogenic coolant in the evaporator heat exchanger unit 106.

Here, the control unit 120 of the electric vehicle 100 may be configured to detect an extreme operating situation or an imminent extreme operating situation of the electric vehicle 100, which may necessitate a temperature-induced power limitation of the constituent 104 or a temperature-induced power reduction of the constituent 104.

If such an extreme operating situation has been detected or is imminent, the control unit 120 may cause the inlet valve 110 to open, so that cryogenic coolant may flow from the tank 108 into the evaporator heat exchanger unit 106. At the same time, the control unit 120 may cause the outlet valve 114 to remain closed. If a predefined amount of the cryogenic coolant is then present in the evaporator heat exchanger unit 106, the control unit 120 may cause the inlet valve 110 to close again. The initially-liquid cryogenic coolant then evaporates within the evaporator heat exchanger unit 106 and, in this way, cools the coolant flowing in the coolant circuit 102, also by way of evaporative cooling. As a result of lowering the temperature of the coolant in the coolant circuit 102 below a predefined threshold value, or as a result of maintaining the temperature below said threshold value, the power limitation or the power reduction of the constituent may be suppressed by the control unit 120.

In order to prevent unnecessary consumption of the cryogenic coolant, the outlet valve 114 may be opened only when the cryogenic coolant within the evaporative heat exchanger unit 106 has completely transitioned into the gas phase, as the cryogenic coolant may then be safely discharged into the vehicle environment via the outlet 116. If an increased cooling capacity is required, for example, when a sustained extreme operating situation is detected, cryogenic coolant may be supplied to the evaporator heat exchanger unit 106 in a pulsed or continuous manner.

The control unit 120 may further be configured to predictively determine an imminent extreme mode of operation, this determination being made, for example, on the basis of data on the operating history and/or on the basis of navigation data and/or on the basis of weather data and/or on the basis of environmental data. In this way, it is also possible that the temperature of the coolant in the coolant circuit 102 is lowered by way of the cryogenic coolant even before the extreme mode of operation occurs, so that a thermal power reserve is created in order to suppress a later power limitation or a later power reduction of the constituent 104.

The present disclosure, therefore, has the advantage that electric vehicles 100 may be operated at their full power, even when the electric vehicles 100 would normally be subjected to a performance derating. Such a configuration may offer increased safety, for example, when driving off-road, improved continuous load performance, and increased efficiency of the electric vehicle 100.

German patent application no. 102025103378.1, filed January 30, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method of operating an electric vehicle, comprising:
detecting an extreme operating situation or an imminent extreme operating situation of the electric vehicle requiring a temperature-induced power limitation of at least one constituent for a drive of the electric vehicle or a temperature-induced power reduction of the at least one constituent for the drive of the electric vehicle; and
evaporating a cryogenic coolant in an evaporator heat exchanger unit, such that a temperature of primary coolant flowing through a coolant circuit is maintained or lowered below a threshold value, such that the power limitation or the power reduction of the at least one constituent for the drive of the electric vehicle is suppressed,
wherein the at least one constituent for the drive of the electric vehicle and the evaporator heat exchanger unit are fluid-mechanically integrated, and
wherein the evaporator heat exchanger unit is configured to be fluid-mechanically connected to a tank configured to hold the cryogenic coolant.

2. The method according to claim 1, further comprising:
introducing a predefined amount of the cryogenic coolant into the evaporator heat exchanger unit when the extreme operating situation or the imminent extreme operating situation is detected; and
discharging the cryogenic coolant from the evaporator heat exchanger unit when the cryogenic coolant in the evaporator heat exchanger unit has completely evaporated.

3. The method according to claim 2, further comprising introducing further cryogenic coolant into the evaporator heat exchanger unit in a pulsed or continuous manner when a sustained extreme operating situation is detected.

4. The method according to claim 2, wherein the introducing of the predefined amount of the cryogenic coolant into the evaporator heat exchanger unit includes opening an inlet valve integrated into a supply line extending from the tank to the evaporator heat exchanger unit.

5. The method according to claim 2, wherein the discharging of the cryogenic coolant from the evaporator heat exchanger unit includes opening an outlet valve integrated into an outlet line extending from the evaporator heat exchanger unit to an outlet to a vehicle environment.

6. The method according to claim 1, wherein the detecting of the imminent extreme operating mode is determined predictively.

7. The method according to claim 6, wherein a predictive determination of the imminent extreme operating mode is made using data on operating history and/or navigation data and/or weather data and/or environmental data.

8. The method according to claim 6, wherein a temperature in the coolant circuit is lowered before the imminent extreme operating mode occurs.

9. The method according to claim 1, wherein the detecting of the extreme operating situation or the imminent extreme operating situation takes place only when a predetermined driving profile is set.

10. An electric vehicle comprising:
a coolant circuit configured for primary coolant to flow therethrough;
at least one constituent for a drive of the electric vehicle;
a tank configured to hold cryogenic coolant;
a control unit; and
an evaporator heat exchanger unit configured to be fluid-mechanically connected to the tank and to be connected to the control unit,
wherein the at least one constituent for the drive of the electric vehicle and the evaporator heat exchanger unit are fluid-mechanically integrated into the coolant circuit, and
wherein the control unit is configured to carry out a method comprising:
detecting an extreme operating situation or an imminent extreme operating situation of the electric vehicle requiring a temperature-induced power limitation of the at least one constituent for the drive of the electric vehicle or a temperature-induced power reduction of the at least one constituent for the drive of the electric vehicle; and
evaporating the cryogenic coolant in the evaporator heat exchanger unit, such that a temperature of the primary coolant is maintained or lowered below a threshold value, such that the power limitation or the power reduction of the at least one constituent for the drive of the electric vehicle is suppressed.
